(19) United States
(12) Patent Application Publication
(10) Pub. No.: US 2015/0149582 A1
(43) Pub. Date: May 28, 2015

(54) SENDING MOBILE APPLICATIONS TO MOBILE DEVICES FROM PERSONAL COMPUTERS

(71) Applicant: International Business Machines Corporation, Armonk, NY (US)

(72) Inventors: Stefan A. Hepper, Morgan Hill, CA (US); Jaspreet Singh, Delhi (IN)

(73) Assignee: International Business Machines Corporation, Armonk, NY (US)

(21) Appl. No.: 14/088,603

(22) Filed: Nov. 25, 2013

(51) Int. Cl. H04L 29/08

(52) U.S. Cl. CPC H04L 67/10
USPC 709/217

(57) ABSTRACT

A tool for sending a mobile application to a mobile device from a computer. The tool receives a request to retrieve a mobile application for a website, or a part of a website. The tool retrieves a mobile device identifier for a mobile device from a social profile. The tool creates the mobile application for the website, or a part of the website. The tool sends the mobile application to the mobile device.

### FIELD OF THE INVENTION

The present invention relates generally to communication systems, and more particularly to, communication between a mobile device and a computer.

### BACKGROUND OF THE INVENTION

Websites are increasingly being offered alternatively as mobile applications for mobile device users. However, retrieving mobile enabled versions (mobile applications) of websites involves multiple steps that impact ease of use.

Currently, a mobile application for a website is designed and uploaded to an application (app) store. A mobile device user navigates to an app store, retrieves a mobile application for a website, and then installs the mobile application for a website on the user's mobile device. All of the foregoing steps take place on the user's mobile device.

When browsing a website from a personal computer, retrieving a mobile enabled version of the website is not intuitive.

### SUMMARY

In an embodiment of the present invention, a method, system, and computer program product are disclosed for sending a mobile application to a mobile device from a personal computer. A computer receives, by one or more computer processors, a request to retrieve a mobile application for a website, or a part of a website, where the request to retrieve a mobile application for the website originates from a personal computer. The computer retrieves, by one or more computer processors, from a social profile a mobile device identifier for a mobile device, wherein a mobile device identifier includes a phone number for a mobile device receiving the mobile application. The computer creates, by one or more computer processors, a mobile application for the website dynamically; wherein creating the mobile application for the web site dynamically includes deriving the mobile application from website code. The computer sends, by one or more computer processors, the mobile application to the mobile device to download and install.

### BRIEF DESCRIPTION OF THE SEVERAL VIEWS OF THE DRAWINGS

FIG. 1 is a functional block diagram illustrating a data processing environment, generally designated 100, in accordance with an embodiment of the present invention.

FIG. 2 is a flowchart of an exemplary process flow, generally designated 200, for creating and sending a mobile application to a mobile device from a computer, in accordance with an embodiment of the present invention.

FIG. 3 is a block diagram depicting components of a data processing system (such as the server computer and client computers of FIG. 1), generally designated 300, in accordance with an embodiment of the present invention.

### DETAILED DESCRIPTION

Embodiments of the present invention recognize that retrieving a mobile enabled version of a website involves performing multiple steps from a mobile device that impact ease of use, and that there is a need for a convenient way to retrieve a mobile application for a website, or a part of a website, for use on a mobile device, from a computer.

Embodiments of the present invention provide the capability to retrieve a mobile enabled version of a website, or a part of a website, from a computer without performing multiple steps on a mobile device by utilizing a program to create a mobile enabled version of a website, and then send the mobile enabled version of the website to the user's mobile device.

Implementation of such embodiments may take a variety of forms, and exemplary implementation details are discussed subsequently with reference to the Figures.

As will be appreciated by one skilled in the art, aspects of the present invention may be embodied as a method, system, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer-readable media having computer readable program code/instructions embodied thereon.

Any combination of computer-readable media may be utilized. Computer-readable media may be a computer-readable signal medium or a computer-readable storage medium. A computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by, or in connection with, an instruction execution system, apparatus, or device.

A computer-readable signal medium may include a propagated data signal with computer-readable program code embodied therein, for example, in baseband or as part of a carrier wave. Such a propagated signal may take any of a variety of forms including, but not limited to, electro-magnetic, optical, or any suitable combination thereof. A computer-readable signal medium may be any computer-readable medium that is not a computer-readable storage medium and that can communicate, propagate, or transport a program for use by, or in connection with, an instruction execution system, apparatus or device.

Program code embodied on a computer-readable medium may be transmitted using any appropriate medium including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like, and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture, including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer-implemented process such that the instructions that execute on the computer or other programmable apparatus provide processes for implementing the functions/acts specified in the flowchart and/or block diagram block or blocks.

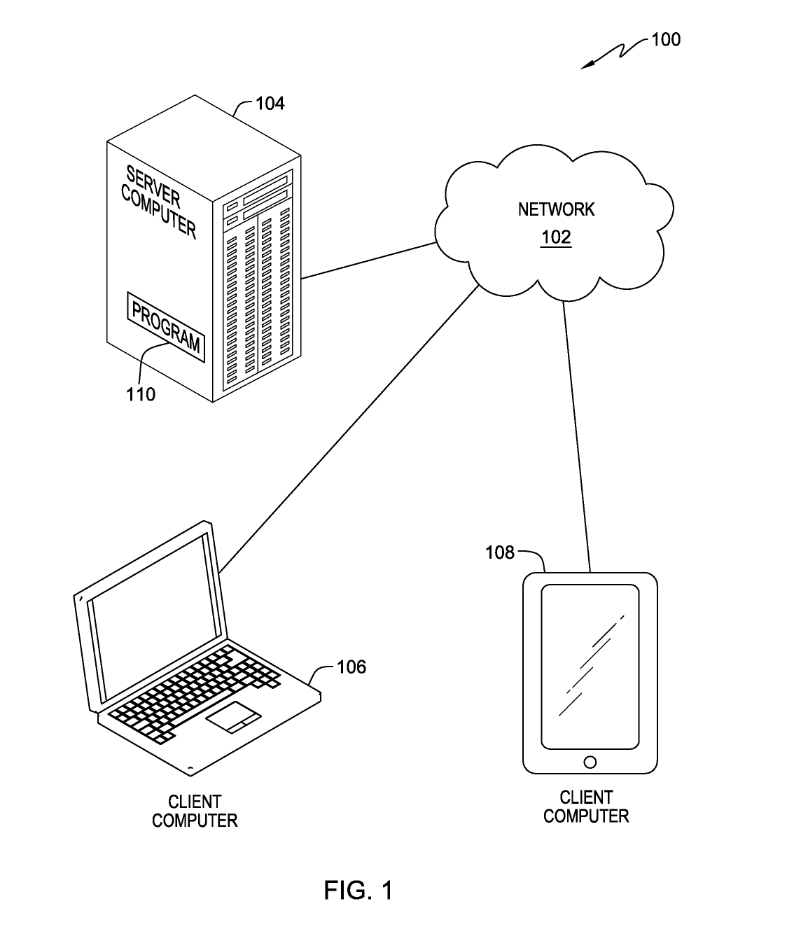

The present invention will now be described in detail with reference to Figures. FIG. 1 illustrates a data processing environment, generally designated 100, according to an exemplary embodiment of the present invention. Data processing environment 100 comprises network 102, server computer 104, and multiple client computers such as client computers 106 and 108.

Network 102 may include wire cables, wireless communication links, fiber optic cables, routers, switches and/or firewalls. Server computer 104 and client computers 106 and 108 are interconnected by network 102. In the exemplary embodiment, network 102 is the Internet representing a worldwide collection of networks and gateways that use TCP/IP protocols to communicate with one another. Network 102 may be implemented as a number of different types of networks, such as an intranet, a local area network (LAN), or a wide area network (WAN). FIG. 1 is intended as an example, and not as an architectural limitation for the different embodiments.

In the exemplary embodiment, server computer 104 may be, for example, a server computer system such as a management server, web server, or any other electronic device or computing system capable of sending and receiving data. In another embodiment, server computer 104 represents a “cloud” of computers interconnected by one or more networks, where server computer 104 is a computing system utilizing clustered computers and components to act as a single pool of seamless resources when accessed through network 102. This is a common implementation for data centers in addition to cloud computing applications.

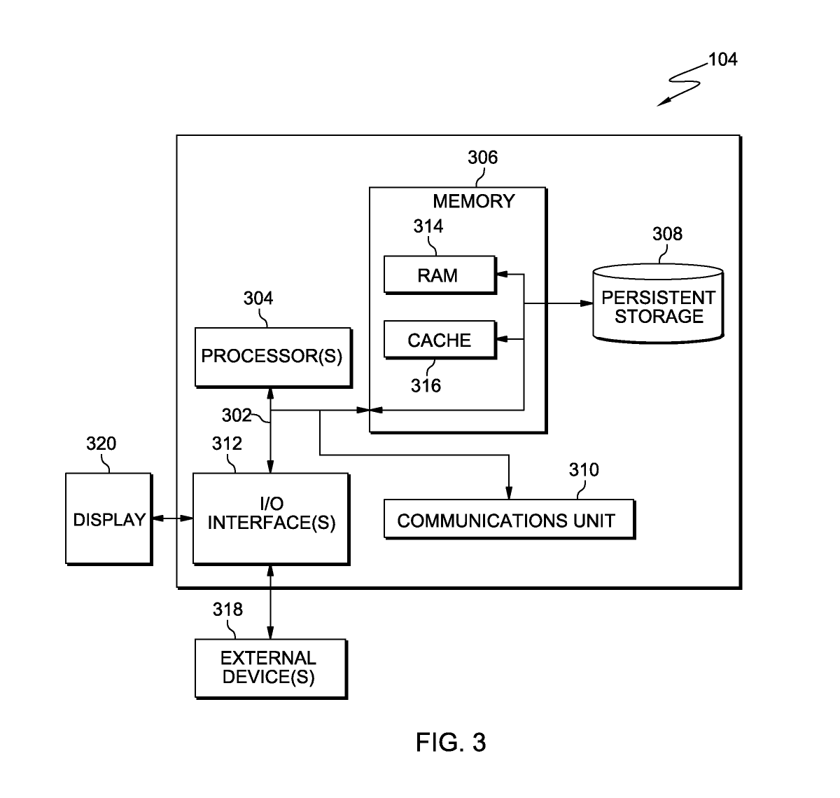

Server computer 104 executes program 110 for creating a mobile enabled version of a website (a mobile application) and transferring the mobile application to a mobile device, such as client computer 108. Server computer 104 and client computers 106 and 108 each maintain respective internal components and respective external components. In general, server computer 104 and client computers 106 and 108 can be any programmable electronic device, as described in further detail with respect to FIG. 3.

In the exemplary embodiment, client computers 106 and 108 are clients to server computer 104, and may be, for example, notebook computers, laptop computers, tablet computers, smart phones, thin clients, or any other electronic devices or computing systems capable of communicating with server computer 104 through network 102.

Program 110 includes a plurality of programs and functions to create a mobile application and send the mobile application to a mobile device, such as client computer 108. In the exemplary embodiment, program 110, in response to receiving a request to retrieve a mobile enabled version of a website, i.e., a mobile application, creates a mobile application for a website, or a part of a website, and sends the mobile application to a mobile device.

Data processing environment 100 may include additional server computers, client computers, displays, and other devices not shown.

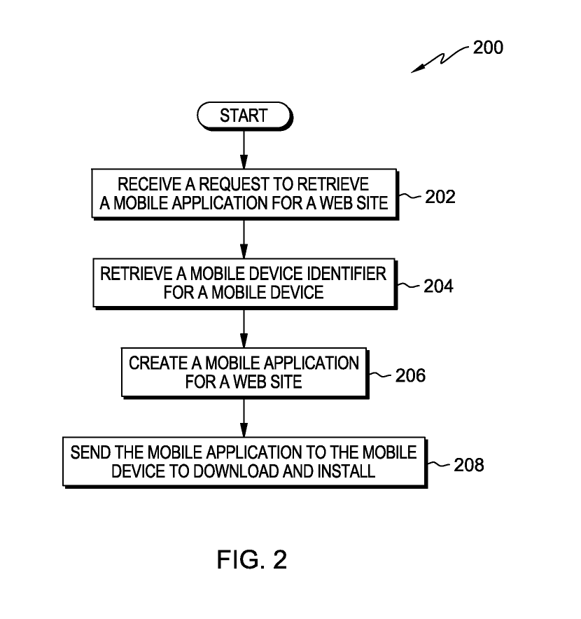

FIG. 2 is a flowchart depicting the steps of program 110 for creating and sending a mobile application to a mobile device from a computer, in accordance with an embodiment of the present invention.

Program 110 receives a request to retrieve a mobile enabled version of a website, or a part of a website, i.e., a mobile application (step 202). In the exemplary embodiment, program 110 receives the request to retrieve the mobile application of the website, or a part of a website, from a browser. A link initiated on a website generates the request, and the browser transmits the request to a server, such as server computer 104. For example, a user browses a website, such as a portal, on a desktop computer. The user desires a mobile application of the portal for their mobile device, locates a link on the portal that says, “Get mobile app,” and initiates the request to retrieve the mobile application by clicking the link. The browser transmits the request to the server where program 110 receives the request. In another embodiment, program 110 receives a request to retrieve a mobile application of a particular feature of a website. For example, a user browses a website, such as a portal, on a desktop computer. The user desires a mobile application of a particular feature (e.g., loan calculator, stock ticker, news feed, etc.) of the portal for their mobile device, locates a link on the portal that says, “Send to phone,” and initiates the request to retrieve the mobile application of the particular feature by clicking the link. The browser transmits the request to the server where program 110 receives the request.

Program 110 retrieves mobile device identifiers (step 204). In the exemplary embodiment, program 110 retrieves mobile device identifiers by accessing social profiles of the user requesting a mobile application of a website. For example, when the user clicks the link “Get mobile app” on a website from a desktop computer, program 110 retrieves mobile device identifiers, such as a mobile phone number, from the user's social profiles (e.g., Facebook®, LinkedIn®, or third party provider profiles, etc.). Program 110 retrieves the mobile device identifiers without prompting the user to enter mobile device identifiers manually every time the user requests a mobile application of a website. In the exemplary embodiment, social profiles, such as those created for social networks, may be stored on a server, such as server computer 104. In another embodiment, social profiles may be retrieved from cloud databases.

Program 110 creates a mobile application for a website, or a part of it (step 206). In the exemplary embodiment, program 110 creates a mobile application of a website dynamically, thereby providing the latest version of the mobile application. For example, program 110 may utilize software, such as software capable of creating mobile applications, to dynamically create a mobile application, from website code base, and deployment mechanisms that capture the latest updates to functionality offered by the website.

Program 110 sends the mobile application to the mobile device for download and installation (step 208). In the exemplary embodiment, program 110 sends the mobile application to the mobile device as a push mechanism, such as a notification, through an established connection with the mobile device. For example, program 110 may establish connectivity with the mobile device by using an IP address of the mobile device. The IP address for the mobile device may be retrieved from an internet provider (e.g., 4G LTE, 3G, etc.) through the mobile phone number. Program 110 may utilize mobile networking Dynamic DNS services to map a static host name to a remote mobile device, and through the static host name, identify the IP address of the remote mobile device. Program 110 may automatically send the mobile application to the user's mobile device as a push mechanism. For example, the mobile application may appear as a notification on the mobile device for the user to click to download and install the mobile application.

FIG. 3 depicts a block diagram of components of server computer 104, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Server computer 104 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications, and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Program 110 can be stored in persistent storage 308 for execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including client computers 106 and 108. In these examples, communications unit 310 includes one or more network interface cards. Communications unit 310 may provide communications through the use of either or both physical and wireless communications links. Program 110 may be downloaded to persistent storage 308 through communications unit 310.

I/O interface(s) 312 allows for input and output of data with other devices that may be connected to server computer 102. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., program 110, can be stored on such portable computer-readable storage media and can be loaded onto persistent storage 308 via I/O interface(s) 312. I/O interface(s) 312 also connect to a display 320.

Display 320 provides a mechanism to display data to a user and may be, for example, a computer monitor.

The programs described herein are identified based upon the application for which they are implemented in a specific embodiment of the invention. The terminology used herein is for the purpose of describing particular embodiments only and is not intended to be limiting of the invention. It should be appreciated that any particular nomenclature herein is used merely for convenience and thus, the invention should not be limited to use solely in any specific function identified and/or implied by such nomenclature. Furthermore, as used herein, the singular forms of “a,” “an,” and “the” are intended to include the plural forms as well, unless the context clearly indicates otherwise.

The description of the present invention has been presented for purposes of illustration and description, but is not intended to be exhaustive or limited to the invention in the form disclosed. Many modifications and variations will be apparent to persons of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1.-6. (canceled)

7. A computer program product comprising:
one or more computer-readable storage devices and program instructions stored on the one or more computer-readable storage devices, the program instructions comprising:
program instructions to receive, by one or more computer processors, a request to retrieve a mobile application for a website, or a part of a website, wherein the request to retrieve a mobile application originates from a computer;
program instructions to retrieve, by one or more computer processors, a mobile device identifier for a mobile device, without prompting a user to manually enter the mobile device identifier, wherein the mobile device identifier includes a phone number for the mobile device receiving the mobile application;
program instructions to create, by one or more computer processors, the mobile application for the website, or a part of the website; and
program instructions to send, by one or more computer processors, the mobile application to the mobile device.

8. The computer program product of claim 7, wherein program instructions to receive a request to retrieve a mobile application for a website, or a part of a website, further comprise program instructions to receive the request to retrieve a mobile application for a website, or a part of a website, from a link initiating the request and a browser delivering the request to a server.

9. The computer program product of claim 7, wherein program instructions to retrieve the mobile device identifier for the mobile device, further comprise program instructions to retrieve the mobile device identifier from at least or more of: a social profile, a single sign on, and a plurality of user information.

10. The computer program product of claim 7, wherein program instructions to create the mobile application for the website, or a part of the website, further comprise program instructions to derive the mobile application from at least one or more of: website code, a portal page, and a portlet.

11. The computer program product of claim 7, wherein program instructions to send the mobile application to the mobile device, further comprise program instructions to send the mobile application to the mobile device via a push mechanism to enable downloading and installation of the mobile application.

12. The computer program product of claim 11, wherein program instructions to send the mobile application to the mobile device via a push mechanism, further comprise program instructions to retrieve an IP address for the mobile device using the phone number for the mobile device, wherein the IP address for the mobile device enables at least one or more of: identification of the mobile device receiving the mobile application, and connectivity with the mobile device receiving the mobile application.

13. A system comprising:
one or more computer processors;
one or more computer-readable storage devices;
program instructions stored on at least one of the one or more computer-readable storage devices for execution by at least one of the one or more computer processors, the program instructions comprising:
program instructions to receive, by one or more computer processors, a request to retrieve a mobile application for a website, or a part of a website, wherein the request to retrieve a mobile application originates from a computer;
program instructions to retrieve, by one or more computer processors, a mobile device identifier for a mobile device, without prompting a user to manually enter the mobile device identifier, wherein the mobile device identifier includes a phone number for the mobile device receiving the mobile application;
program instructions to create, by one or more computer processors, the mobile application for the website, or a part of the website; and
program instructions to send, by one or more computer processors, the mobile application to the mobile device.

14. The computer system of claim 13, wherein program instructions to receive a request to retrieve a mobile application for a website, or a part of a website, further comprise program instructions to receive the request to retrieve a mobile application for a website, or a part of a website, from a link initiating the request and a browser delivering the request to a server.

15. The computer system of claim 13, wherein program instructions to retrieve the mobile device identifier for the mobile device, further comprise program instructions to retrieve the mobile device identifier from at least or more of: a social profile, a single sign on, and a plurality of user information.

16. The computer system of claim 13, wherein program instructions to create the mobile application for the website, or a part of the website, further comprise program instructions to derive the mobile application from at least one or more of: website code, a portal page, and a portlet.

17. The computer system of claim 13, wherein program instructions to send the mobile application to the mobile device, further comprise program instructions to send the mobile application to the mobile device via a push mechanism to enable downloading and installation of the mobile application.

18. The computer system of claim 17, wherein program instructions to send the mobile application to the mobile device via a push mechanism, further comprise program instructions to retrieve an IP address for the mobile device using the phone number for the mobile device, wherein the IP address for the mobile device enables at least one or more of: identification of the mobile device receiving the mobile application, and connectivity with the mobile device receiving the mobile application.
